(19) United States
(12) Patent Application Publication
(10) Pub. No.: US 2023/0146192 A1
(43) Pub. Date: May 11, 2023

(54) POST PROCESSING SYSTEM AND POST PROCESSING METHOD FOR RECONSTRUCTED IMAGES AND NON-TRANSITORY COMPUTER READABLE MEDIUM

(71) Applicant: Charles Tak Ming CHOI, Hsinchu City (TW)

(72) Inventor: Charles Tak Ming CHOI, Hsinchu City (TW)

(21) Appl. No.: 17/883,086

(22) Filed: Aug. 8, 2022

(30) Foreign Application Priority Data
Aug. 13, 2021 (TW) 110130025

(51) Int. Cl. G06T 11/00; G06N 3/044

(52) U.S. Cl. CPC G06T 11/008; G06N 3/044; G06T 2210/41; G06T 2211/424

(57) ABSTRACT

A method for image postprocessing includes steps as follows. A first reconstructed image is generated through a solving method according to the measuring data. The measuring data is measured by an image capturing device, and the image capturing device is selected from a group consisting of a magnetic induction tomography (MIT) device, a magnetoacoustic tomography with magnetic induction (MAT-MI) device, a magneto-acoustic-electrical tomography device, a ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device and, an imaging photoplethysmogram (PPG) device, or the like. Then, the first reconstructed image is post-processed through a neural network algorithm to generate a second reconstructed image.

### RELATED APPLICATIONS

This application claims priority to Taiwan Application Serial Number 110130025, filed Aug. 13, 2021, which is herein incorporated by reference.

### BACKGROUND

### Technical Field

The present invention relates to an image post processing technology. More particularly, the present invention relates to a post processing system and a post processing method for images.

### Description of Related Art

Electrical impedance tomography (EIT) is a medical imaging technology for generating tomographic images according to conductivity distribution of a certain portion of a body. Electrical impedance tomography is an inexpensive, noninvasive tomographic imaging technology free of ionizing radiation.

However, the electrical impedance tomography has a drawback of having poor image resolution, which results from limited number of electrode for data acquisition. Whereas when the number of electrode is increased, cost is also increased and there is a limit of how much resolution can be improved by increasing the number of electrodes, which means that increasing the number of electrode is not a good solution to improve image resolution.

### SUMMARY

An aspect of the present disclosure is a post processing system for images. The post processing system comprises a processing device and a post processing device, and the post processing device is coupled to the processing device. The processing device is configured to generate a first reconstructed image through a solving method based on measuring data. The measuring data is measured by an image capturing device. The image capturing device is selected from a group consisting of a magnetic induction tomography (MIT) device, a magnetoacoustic tomography with magnetic induction (MAT-MI) device, an ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device, an imaging photoplethysmogram (PPG) device, a microwave tomography device, a magneto-acoustic-electrical tomography device, a thermoacoustic tomography device, a thermoacoustic molecular tomography device, a magnetically mediated thermoacoustic imaging device, a microwave induced thermal acoustic tomography device, a single-photon emission computed tomography device, a Lorentz force electrical impedance tomography device and a magneto-photo-acoustic imaging device. The first reconstructed image is selected from a group consisting of a first MIT image, a first MAT-MI image, a first ultrasound image, a first PET image, a first CT image, a first MRI image, a first microwave tomography image, a first pressure tomography image, a first optical coherence tomography image, a first doppler ultrasonography image, a first mammogram image, a first imaging PPG image, a first microwave tomography image, a first magneto-acoustic-electrical tomography image, a first thermoacoustic tomography image, a first thermoacoustic molecular tomography image, a first magnetically mediated thermoacoustic imaging image, a first microwave induced thermal acoustic tomography image, a first single-photon emission computed tomography image, a first Lorentz force reconstructed image and a first magneto-photo-acoustic imaging image. The post processing device is configured to receive the first reconstructed image and post-process the first reconstructed image through a neural network algorithm to generate a second reconstructed image. The second reconstructed image is selected from a group consisting of a second MIT image, a second MAT-MI image, a second ultrasound image, a second PET image, a second CT image, a second MRI image, a second microwave tomography image, a second pressure tomography image, a second optical coherence tomography image, a second doppler ultrasonography image, a second mammogram image, a second imaging PPG image, a second microwave tomography image, a second magneto-acoustic-electrical tomography image, a second thermoacoustic tomography image, a second thermoacoustic molecular tomography image, a second magnetically mediated thermoacoustic imaging image, a second microwave induced thermal acoustic tomography image, a second single-photon emission computed tomography image, a second Lorentz force reconstructed image and a second magneto-photo-acoustic imaging image.

Another aspect of the present disclosure is a post processing method for images. The post processing method comprises steps of: by a processing device, generating a first reconstructed image through a solving method based on measuring data, wherein the measuring data is measured by an image capturing device, wherein the measuring data is measured by an image capturing device, and the image capturing device is selected from a group consisting of a magnetic induction tomography (MIT) device, a magnetoacoustic tomography with magnetic induction (MAT-MI) device, an ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device, an imaging photoplethysmogram (PPG) device, a microwave tomography device, a magneto-acoustic-electrical tomography device, a thermoacoustic tomography device, a thermoacoustic molecular tomography device, a magnetically mediated thermoacoustic imaging device, a microwave induced thermal acoustic tomography device, a single-photon emission computed tomography device, a Lorentz force electrical impedance tomography device and a magneto-photo-acoustic imaging device, and the first reconstructed image is selected from a group consisting of a first MIT image, a first MAT-MI image, a first ultrasound image, a first PET image, a first CT image, a first MRI image, a first microwave tomography image, a first pressure tomography image, a first optical coherence tomography image, a first doppler ultrasonography image, a first mammogram image, a first imaging PPG image, a first microwave tomography image, a first magneto-acoustic-electrical tomography image, a first thermoacoustic tomography image, a first thermoacoustic molecular tomography image, a first magnetically mediated thermoacoustic imaging image, a first microwave induced thermal acoustic tomography image, a first single-photon emission computed tomography image, a first Lorentz force reconstructed image and a first magneto-photo-acoustic imaging image; by a post processing device, post-processing the first reconstructed image through a neural network algorithm to generate a second reconstructed image, wherein the second reconstructed image is selected from a group consisting of a second MIT image, a second MAT-MI image, a second ultrasound image, a second PET image, a second CT image, a second MRI image, a second microwave tomography image, a second pressure tomography image, a second optical coherence tomography image, a second doppler ultrasonography image, a second mammogram image, a second imaging PPG image, a second microwave tomography image, a second magneto-acoustic-electrical tomography image, a second thermoacoustic tomography image, a second thermoacoustic molecular tomography image, a second magnetically mediated thermoacoustic imaging image, a second microwave induced thermal acoustic tomography image, a second single-photon emission computed tomography image, a second Lorentz force reconstructed image and a second magneto-photo-acoustic imaging image.

In practice, the electrical impedance tomography image only shows the relative amplitude of the object (foreground) and background, increasing the number of electrodes might increase the resolution of the electrical impedance tomography image only to a certain limit only. The reconstructed image of the present disclosure can show the absolute amplitude of the object (foreground) and the background. The reconstructed image is post-processed to produce a highly accurate reconstructed image, and the generation speed is relatively fast. In addition, the present disclosure can also directly generate the highly accurate reconstructed image from the measurement data through a neural network, and the generation speed is relatively fast.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic diagram of a post processing system for images according to an embodiment of the present disclosure;

FIGS. 2A-2C are schematic diagrams of neural networks according to some embodiments of the present disclosure;

FIG. 3 is a schematic diagram of a neural network according to an embodiment of the present disclosure;

FIG. 4 is a flow chart of a post processing method for images according to an embodiment of the present disclosure;

FIG. 5 is a flow chart of a post processing method for images according to an embodiment of the present disclosure;

FIG. 6 is a schematic diagram of a processing device according to an embodiment of the present disclosure;

FIG. 7 is a schematic diagram of a processing device according to an embodiment of the present disclosure;

FIG. 8 is a flow chart of a processing method according to an embodiment of the present disclosure; and

FIG. 9 is a flow chart of a post processing method according to an embodiment of the present disclosure.

### DETAILED DESCRIPTION

In order to make the description of the disclosure more detailed and comprehensive, reference will now be made in detail to the accompanying drawings and the following embodiments. However, the provided embodiments are not used to limit the ranges covered by the present disclosure; orders of step description are not used to limit the execution sequence either. Any devices with equivalent effect through rearrangement are also covered by the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise indicated, all numbers expressing quantities, conditions, and the like in the instant disclosure and claims are to be understood as modified in all instances by the term “about.” The term “about” refers, for example, to numerical values covering a range of plus or minus 20% of the numerical value. The term “about” preferably refers to numerical values covering range of plus or minus 10% (or most preferably, 5%) of the numerical value. The modifier “about” used in combination with a quantity is inclusive of the stated value.

In this document, the term “coupled” may also be termed as “electrically coupled”, and the term “connected” may be termed as “electrically connected,” “coupled” and “connected” may also be used to indicate that two or more elements cooperate or interact with each other.

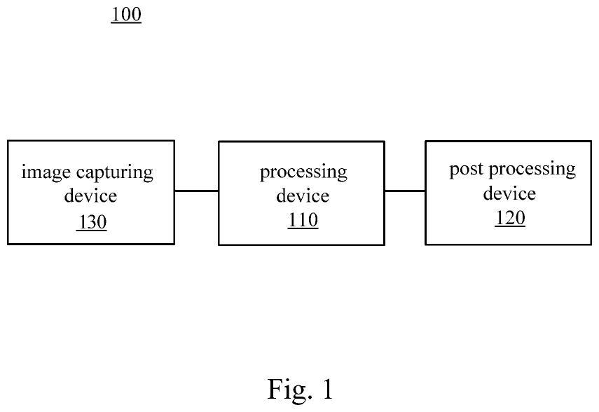

Reference is made to FIG. 1. FIG. 1 is a schematic diagram of a post processing system 100 for images according to an embodiment of the present disclosure. As shown in FIG. 1, the post processing device 120 is coupled to the processing device 110, and the image capturing device 130 is coupled to the processing device 110. The image capturing device 130 is configured to measure the measuring data from the object. The processing device 110 is configured to generate a first reconstructed image based on the measuring data. In an embodiment, the image capturing device 130 can be a magnetic induction tomography (MIT) device, a magnetoacoustic tomography with magnetic induction (MAT-MI) device, an ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device, an imaging photoplethysmogram (PPG) device, a microwave tomography device, a magneto-acoustic-electrical tomography device, a thermoacoustic tomography device, a thermoacoustic molecular tomography device, a magnetically mediated thermoacoustic imaging device, a microwave induced thermal acoustic tomography device, a single-photon emission computed tomography device, a Lorentz force electrical impedance tomography device and/or a magneto-photo-acoustic imaging device. The first reconstructed image can be a first MIT image, a first MAT-MI image, a first ultrasound image, a first PET image, a first CT image, a first MRI image, a first microwave tomography image, a first pressure tomography image, a first optical coherence tomography image, a first doppler ultrasonography image, a first mammogram image, a first imaging PPG image, a first microwave tomography image, a first magneto-acoustic-electrical tomography image, a first thermoacoustic tomography image, a first thermoacoustic molecular tomography image, a first magnetically mediated thermoacoustic imaging image, a first microwave induced thermal acoustic tomography image, a first single-photon emission computed tomography image, a first Lorentz force reconstructed image and/or a first magneto-photo-acoustic imaging image.

Specifically, the processing device 110 (e.g., a calculator, a computer, a field-programmable gate array (FPGA), however, the present disclosure is not limited thereto) is configured to generate a first reconstructed image through a solving method based on the measuring data. Generally, a first reconstructed image generated through a solving method is not identical to the actual image of a target object, that is, there is a problem of distortion. Then, the post processing device 120 (e.g., a FPGA, however, the present disclosure is not limited thereto) is configured to post-process the first reconstructed image through a neural network (NN) algorithm to generate a second reconstructed image. In an embodiment, the second reconstructed image can be a second MIT image, a second MAT-MI image, a second ultrasound image, a second PET image, a second CT image, a second MRI image, a second microwave tomography image, a second pressure tomography image, a second optical coherence tomography image, a second doppler ultrasonography image, a second mammogram image, a second imaging PPG image, a second microwave tomography image, a second magneto-acoustic-electrical tomography image, a second thermoacoustic tomography image, a second thermoacoustic molecular tomography image, a second magnetically mediated thermoacoustic imaging image, a second microwave induced thermal acoustic tomography image, a second single-photon emission computed tomography image, a second Lorentz force reconstructed image and/or a second magneto-photo-acoustic imaging image. In the present embodiment, the neural network algorithm used by the post processing device 120 are trained with images generated from processing device 110 and the actual image of a target object, thus, the neural network algorithm can undistort any images generated from processing device 110. Therefore, compared to the first reconstructed image, the second reconstructed image has a higher degree of accuracy. It should be noted that the post processing device 120 uses a trained neural network algorithm to generate the second reconstructed image. In other words, the post processing device 120 uses the neural network algorithm in an application phase to generate the second reconstructed image.

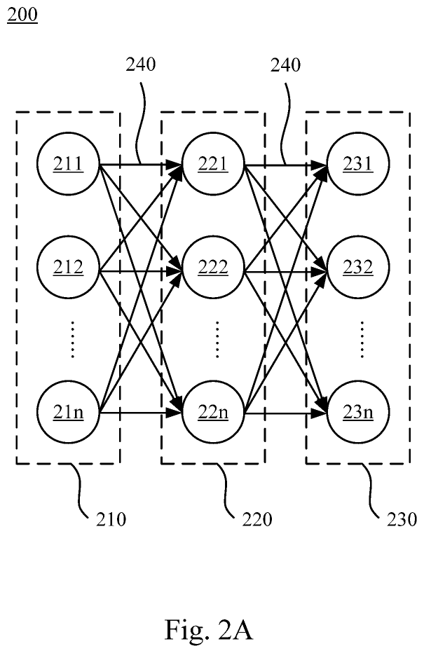

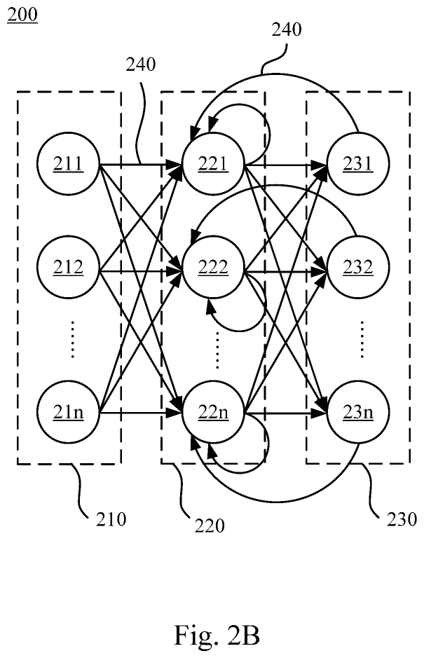

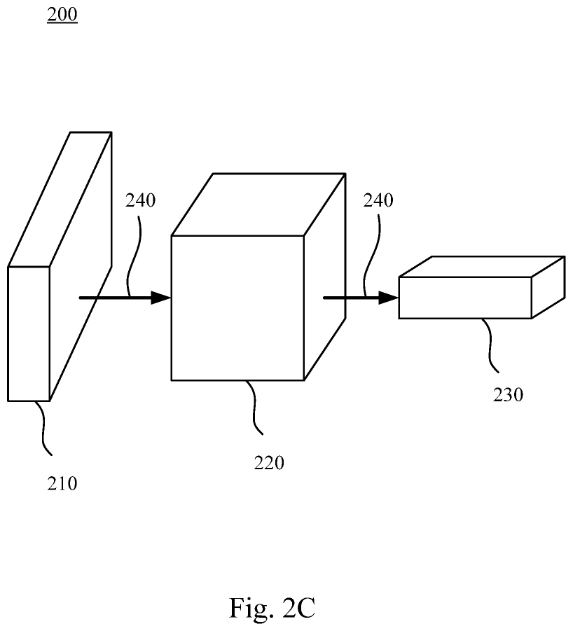

In an embodiment, the neural network algorithm used by the post processing device 120 may be an artificial neural network (ANN) (e.g., feed forward neural network, recurrent neural network or convolutional neural network, however, the present disclosure is not limited thereto) as shown in FIG. 2A-2C. The neural network 200 includes an input layer 210, a hidden layer 220 and an output layer 230. The input layer 210 includes at least one input neuron 211-21n, the hidden layer 220 includes at least one hidden neuron 221-22n, and the output layer 230 includes at least one output neuron 231-23n. There are weighting parameters 240 between the input layer 210 and the hidden layer 220, and between the hidden layer 220 and the output layer 230. In a training phase of the neural network 200, the post processing device 120 may train the neural network 200 through a training image and an actual image to improve accuracy of the second reconstructed image. Specifically, the post processing device 120 may input at least one training image to the input layer 210, and input at least one actual image to the output layer 230 to determine the weighting parameters 240 between the hidden layer 220 and the input layer 210, and between the at least one hidden layer 220 and the output layer 230. It should be noted that the actual image and the training image have a corresponding relationship. Therefore, the post processing device 120 can input the first reconstructed image generated under similar measuring condition to the neural network 200 (with the above determined weighting parameters 240) to generate the second reconstructed image that is a better approximation to the actual image, that is, the second reconstructed image has a higher degree of accuracy than the first reconstructed image.

It should be added that the artificial neural network may be a feedforward neural network (as shown in FIG. 2A), a recurrent neural network (as shown in FIG. 2B) or a convolutional neural network (as shown in FIG. 2C). However, the present disclosure is not limited thereto. Moreover, the input layer 210 and the output layer 230 are not limited to a single layer, and can also be plural layers.

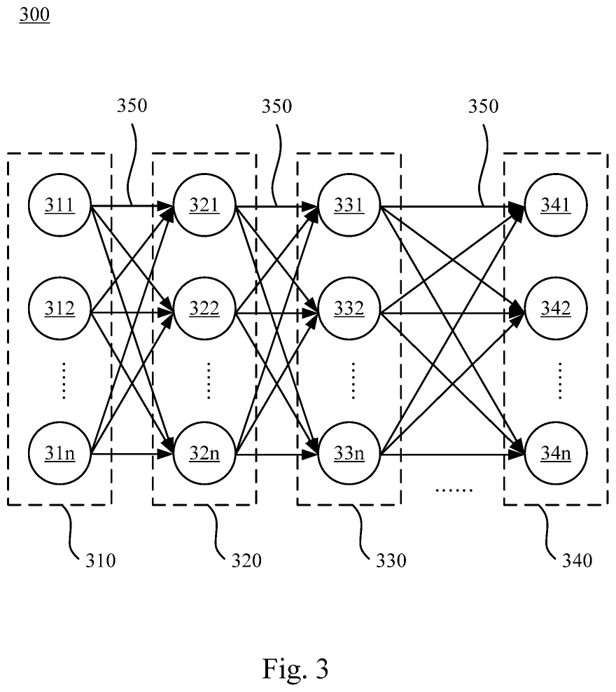

Alternatively, in another embodiment, the neural network algorithm used by the post processing device 120 may be a deep neural network (DNN), as shown in FIG. 3. The neural network 300 includes an input layer 310, a plurality of hidden layers 320, 330 and an output layer 340. The input layer 310 includes at least one input neuron 311-31n, the hidden layer 320 includes at least one hidden neuron 321-32n, the hidden layer 330 includes at least one hidden neuron 331-33n, and the output layer 340 includes at least one output neuron 341-34n. There are weighting parameters 350 between the input layer 310 and the hidden layer 320, between the hidden layer 320 and the output layer 340, and between the hidden layer 330 and the output layer 340. As aforementioned, in a training phase of the neural network 300, the post processing device 120 may train the neural network 300 by the training image and the actual image to improve accuracy of the second reconstructed image, and the description would not be repeated herein. It should be noted that number of the hidden layer in the neural network 300 may be another number, which is not limited to two hidden layers 320, 330, and the weighting parameters 350 between the hidden layers may also be determined through the above training process of the post processing device 120.

Similarly, the deep neural network may be implemented as a feedforward neural network (as shown in FIG. 3), a recurrent neural network or a convolutional neural network. However, the present disclosure is not limited thereto. Moreover, the input layer 310 and the output layer 340 are also not limited to a single layer, and can also be plural layers.

Alternatively, in yet another embodiment, the neural network algorithm used by the post processing device 120 may be a generative adversarial network, a recurrent convolutional neural network, a recursive neural network or the like.

In an embodiment, the training images used by the post processing device 120 to train the neural networks 200, 300 may be generated by the processing device 110 through the solving method (e.g., a linear solving method or a nonlinear solving method) based on training data. Similar to the measuring data, the training data is measured by the image capturing device. Specifically, the user may first use the image capturing device to measure target objects (with known sizes, shapes and positions) to obtain the training data. Then, the processing device 110 generates the training images through the solving method based on the training data. Generally, the training images generated merely through the solving method is not completely identical to an actual image of the target object, that is, there is a problem of distortion. Therefore, the neural networks 200, 300 trained by the post processing device 120 through the training image and the actual image can effectively generate an reconstructed image (i.e., the second reconstructed image) with a higher degree of accuracy than the first reconstructed image. Moreover, time for generating the second reconstructed image by the post processing system 100 through the solving method and the neural network algorithm based on the measuring data is very short (e.g., merely about more than zero seconds, and an actual time for calculation depends on an image size and speeds of the processing device 110 and the post processing device 120).

Alternatively, in another embodiment, the post processing device 120 may post process the first reconstructed image through the neural network algorithm based on the measuring data to generate a third reconstructed image. In an embodiment, the third reconstructed image can be a third MIT image, a third MAT-MI image, a third ultrasound image, a third PET image, a third CT image, a third MRI image, a third microwave tomography image, a third pressure tomography image, a third optical coherence tomography image, a third doppler ultrasonography image, a third mammogram image, a third imaging PPG image, a third microwave tomography image, a third magneto-acoustic-electrical tomography image, a third thermoacoustic tomography image, a third thermoacoustic molecular tomography image, a third magnetically mediated thermoacoustic imaging image, a third microwave induced thermal acoustic tomography image, a third single-photon emission computed tomography image, a third Lorentz force reconstructed image and/or a third magneto-photo-acoustic imaging image. The training method of the neural networks 200, 300 are as aforementioned, and would not be repeated herein. It should be noted that, in the present embodiment, the post processing device 120 may use the measuring data to further calibrate parameter values (e.g., magnetic induction parameters, magnetic induction magneto-acoustic parameters, ultrasonic parameters, positron emission parameters, computed tomography parameters, magnetic resonance parameters) of the first reconstructed image to an actual values, and therefore the third reconstructed image has a higher degree of accuracy. Moreover, time for generating the third reconstructed image by the post processing system 100 through the neural network algorithm based on the measuring data is very short (e.g., merely about more than milli seconds, and an actual time for calculation depends on an image size and speeds of the processing device 110 and the post processing device 120).

As a result, by using the neural network algorithm, the post processing system 100 of the present disclosure can rapidly generate the second reconstructed image with a higher accuracy of image based on the first reconstructed image (which is generated through the solving method). Moreover, the post processing system of the present disclosure can also rapidly generate the third reconstructed image with a higher accuracy of the image and the conductivity based on the measuring data and the first reconstructed image (which is generated through the solving method).

It should be added that the second reconstructed image or the third reconstructed image generated by the post processing device 120 may be a reconstructed image formed by an absolute position.

Since there may be noise in actual measurements, in an embodiment, the post processing device 120 is further configured to determine the weighting parameters 240, 350 based on the noise data. Therefore, the post processing system 100 can further improve accuracy of the reconstructed image.

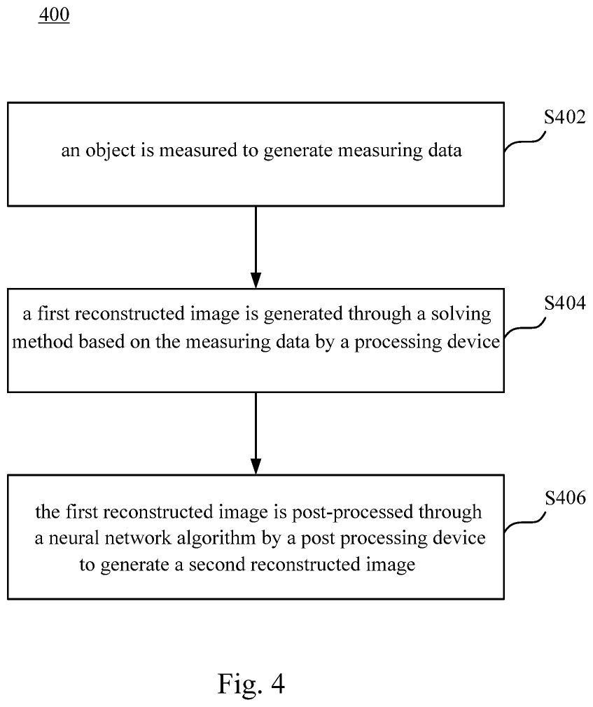

FIG. 4 is a flow chart of a post processing method 400 for reconstructed images according to an embodiment of the present disclosure. The post processing method 1000 includes steps S402-S406, and the post processing method 1000 can be applied to the post processing system 100 as shown in FIG. 1. However, those skilled in the art should understand that the mentioned steps in the present embodiment are in an adjustable execution sequence according to the actual demands except for the steps in a specially described sequence, and even the steps or parts of the steps can be executed simultaneously.

In step S402, an object is measured to generate measuring data by an image capturing device. In an embodiment, the image capturing device can be a magnetic induction tomography (MIT) device, a magnetoacoustic tomography with magnetic induction (MAT-MI) device, an ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device, an imaging photoplethysmogram (PPG) device, a microwave tomography device, a magneto-acoustic-electrical tomography device, a thermoacoustic tomography device, a thermoacoustic molecular tomography device, a magnetically mediated thermoacoustic imaging device, a microwave induced thermal acoustic tomography device, a single-photon emission computed tomography device, a Lorentz force electrical impedance tomography device and/or a magneto-photo-acoustic imaging device.

In step S404, a first reconstructed image is generated through a solving method based on the measuring data by a processing device. In an embodiment, the first reconstructed image can be a first MIT image, a first MAT-MI image, a first ultrasound image, a first PET image, a first CT image, a first MRI image, a first microwave tomography image, a first pressure tomography image, a first optical coherence tomography image, a first doppler ultrasonography image, a first mammogram image, a first imaging PPG image, a first microwave tomography image, a first magneto-acoustic-electrical tomography image, a first thermoacoustic tomography image, a first thermoacoustic molecular tomography image, a first magnetically mediated thermoacoustic imaging image, a first microwave induced thermal acoustic tomography image, a first single-photon emission computed tomography image, a first Lorentz force reconstructed image and/or a first magneto-photo-acoustic imaging image.

In step S406, the first reconstructed image is post-processed through a neural network algorithm by a post processing device to generate a second reconstructed image. In an embodiment, the second reconstructed image can be a second MIT image, a second MAT-MI image, a second ultrasound image, a second PET image, a second CT image, a second MRI image, a second microwave tomography image, a second pressure tomography image, a second optical coherence tomography image, a second doppler ultrasonography image, a second mammogram image, a second imaging PPG image, a second microwave tomography image, a second magneto-acoustic-electrical tomography image, a second thermoacoustic tomography image, a second thermoacoustic molecular tomography image, a second magnetically mediated thermoacoustic imaging image, a second microwave induced thermal acoustic tomography image, a second single-photon emission computed tomography image, a second Lorentz force reconstructed image and/or a second magneto-photo-acoustic imaging image.

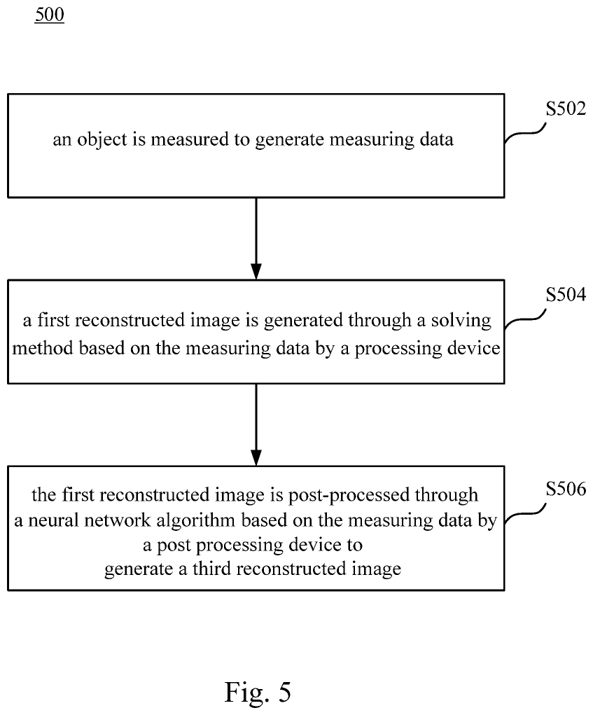

FIG. 5 is a flow chart of a post processing method 500 for reconstructed images according to an embodiment of the present disclosure. The post processing method 500 includes steps S502-S506, and the post processing method 500 can be applied to the post processing system 100 as shown in FIG. 1. However, those skilled in the art should understand that the mentioned steps in the present embodiment are in an adjustable execution sequence according to the actual demands except for the steps in a specially described sequence, and even the steps or parts of the steps can be executed simultaneously.

In step S502, an object is measured to generate measuring data by an image capturing device. In an embodiment, the image capturing device can be a magnetic induction tomography (MIT) device, a magnetoacoustic tomography with magnetic induction (MAT-MI) device, an ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device, an imaging photoplethysmogram (PPG) device, a microwave tomography device, a magneto-acoustic-electrical tomography device, a thermoacoustic tomography device, a thermoacoustic molecular tomography device, a magnetically mediated thermoacoustic imaging device, a microwave induced thermal acoustic tomography device, a single-photon emission computed tomography device, a Lorentz force electrical impedance tomography device and/or a magneto-photo-acoustic imaging device.

In step S504, a first reconstructed image is generated through the solving method based on the measuring data by a processing device. In an embodiment, the first reconstructed image can be a first MIT image, a first MAT-MI image, a first ultrasound image, a first PET image, a first CT image, a first MRI image, a first microwave tomography image, a first pressure tomography image, a first optical coherence tomography image, a first doppler ultrasonography image, a first mammogram image, a first imaging PPG image, a first microwave tomography image, a first magneto-acoustic-electrical tomography image, a first thermoacoustic tomography image, a first thermoacoustic molecular tomography image, a first magnetically mediated thermoacoustic imaging image, a first microwave induced thermal acoustic tomography image, a first single-photon emission computed tomography image, a first Lorentz force reconstructed image and/or a first magneto-photo-acoustic imaging image.

In step S506, the first reconstructed image is post-processed through a neural network algorithm based on the measuring data by a post processing device to generate a third reconstructed image. In an embodiment, the third reconstructed image can be a third MIT image, a third MAT-MI image, a third ultrasound image, a third PET image, a third CT image, a third MRI image, a third microwave tomography image, a third pressure tomography image, a third optical coherence tomography image, a third doppler ultrasonography image, a third mammogram image, a third imaging PPG image, a third microwave tomography image, a third magneto-acoustic-electrical tomography image, a third thermoacoustic tomography image, a third thermoacoustic molecular tomography image, a third magnetically mediated thermoacoustic imaging image, a third microwave induced thermal acoustic tomography image, a third single-photon emission computed tomography image, a third Lorentz force reconstructed image and/or a third magneto-photo-acoustic imaging image.

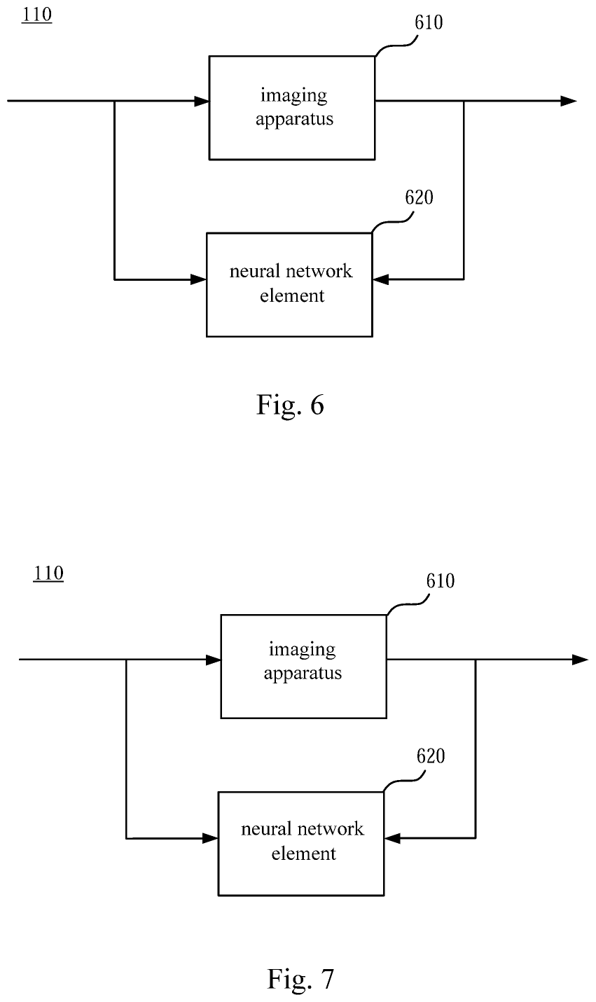

FIG. 6 is a schematic diagram of a processing device according to an embodiment of the present disclosure. As shown in FIG. 6, the processing device 110 includes an imaging apparatus 610 and a neural network element 620. The measurement data output by the imaging device 130 is processed through the imaging apparatus 610 to output a first reconstructed image. The neural network element 620 can compare the measurement data with the first reconstructed image for machine learning.

After the machine learning of the neural network element 620 is completed, as shown in FIG. 7, the imaging apparatus 610 can be replaced with the neural network element 620. The neural network element 620 processes output by the imaging device 130 to output the first reconstructed image. In this way, time can be saved by the faster processing speed of the neural network element 620.

For example, the imaging apparatus 610 can be a magnetic induction tomography (MIT) image formation apparatus, a magnetoacoustic tomography with magnetic induction (MAT-MI) image formation apparatus, an ultrasound image formation apparatus, a positron emission tomography (PET) image formation apparatus, a computed tomography (CT) image formation apparatus, a magnetic resonance imaging (MRI) image formation apparatus, a microwave tomography image formation apparatus, a pressure tomography image formation apparatus, an optical coherence tomography image formation apparatus, a doppler ultrasonography image formation apparatus, a mammogram image formation apparatus, an imaging photoplethysmogram (PPG) image formation apparatus, a microwave tomography image formation apparatus, a magneto-acoustic-electrical tomography image formation apparatus, a thermoacoustic tomography image formation apparatus, a thermoacoustic molecular tomography image formation apparatus, a magnetically mediated thermoacoustic imaging image formation apparatus, a microwave induced thermal acoustic tomography image formation apparatus, a single-photon emission computed tomography image formation apparatus, a Lorentz force electrical impedance tomography image formation apparatus and/or a magneto-photo-acoustic imaging image formation apparatus.

For example, the neural network element 620 may be an artificial neural network (ANN) element, a recurrent neural network (RNN) element, a convolutional neural network (CNN) element, a regional convolutional neural network (RCNN) element, a deep neural network (DNN) element and/or a generative adversarial network (GAN) element.

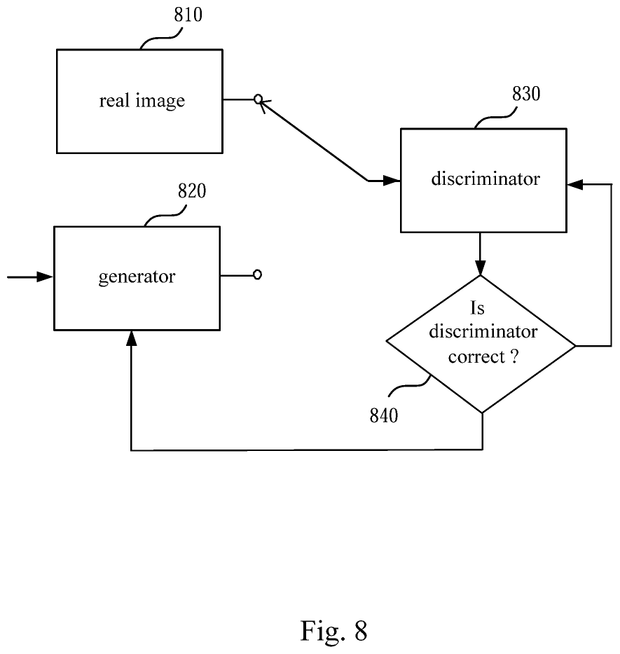

For a more complete of the operation of the generative adversarial Network (GAN) element, please refer to FIG. 8, which is a flow chart of a processing method according to an embodiment of the present disclosure. As shown in FIG. 8, the real image in step 810 can be, for example, the above-mentioned first reconstructed image. In step 820, the generator generates a simulated image based on random data or noise. In step 830, the discriminator discriminates the real image from the simulated image. In step 840, it is determined whether the discrimination of the discriminator is correct. When the discrimination of the discriminator is incorrect, according to the difference between the real image and the simulated image, discrimination level of the discriminator is improved, and the simulation level of the generator is also improved. The aforesaid steps are repeated until the simulated image of the generator is close to the real image.

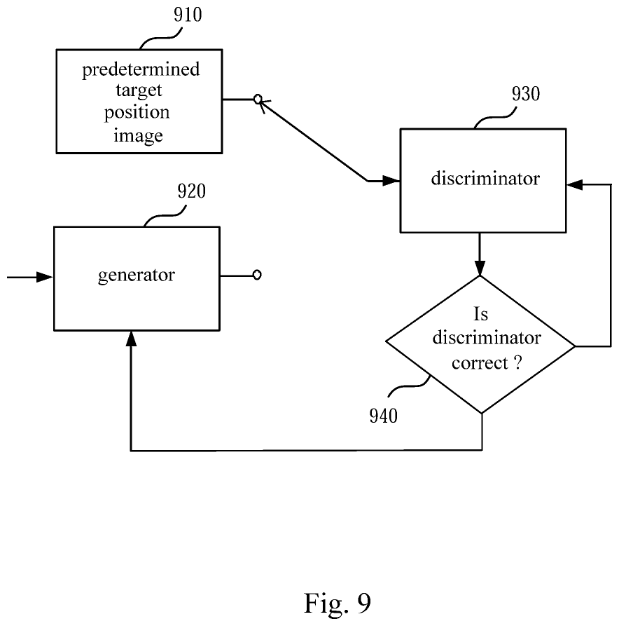

Furthermore, a generative adversarial network (GAN) can also be applied to the post-processing device 130, please refer to FIG. 9, which is a flow chart of a post processing method according to an embodiment of the present disclosure. As shown in FIG. 9, in step 910, a predetermined target position image is provided. In step 820, the generator generates a realistic image based on the data of the predetermined target position measured by the imaging apparatus, where the imaging apparatus is mentioned above or can also be a simulator and/or a hardware and software system. In step 830, the discriminator discriminates the predetermined target position image from the realistic image. In step 840, it is determined whether the discrimination of the discriminator is correct. When the discrimination of the discriminator is incorrect, according to the difference between the predetermined target position image and the realistic image, discrimination level of the discriminator is improved, and the simulation level of the generator is also improved. The aforesaid steps are repeated until the realistic image of the generator is close to the predetermined target position image.

In practice, the electrical impedance tomography image only shows the relative amplitude of the object (foreground) and background, increasing the number of electrodes might increase the resolution of the electrical impedance tomography image only to a certain limit only. The reconstructed image of the present disclosure can show the absolute amplitude of the object (foreground) and the background. The reconstructed image is post-processed to produce a highly accurate reconstructed image, and the generation speed is relatively fast. In addition, the present disclosure can also directly generate the highly accurate reconstructed image from the measurement data through a neural network, and the generation speed is relatively fast.

Above methods of the present disclosure may take the form of a computer program product on a computer-readable storage medium having computer-readable instructions embodied in the medium.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A post processing system for images, comprising:
a processing device configured to generate a first reconstructed image through a solving method based on measuring data, wherein the measuring data is measured by an image capturing device, the image capturing device is selected from a group consisting of a magnetic induction tomography (MIT) device, a magnetoacoustic tomography with magnetic induction (MAT-MI) device, an ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device, an imaging photoplethysmogram (PPG) device, a microwave tomography device, a magneto-acoustic-electrical tomography device, a thermoacoustic tomography device, a thermoacoustic molecular tomography device, a magnetically mediated thermoacoustic imaging device, a microwave induced thermal acoustic tomography device, a single-photon emission computed tomography device, a Lorentz force electrical impedance tomography device and a magneto-photo-acoustic imaging device, and the first reconstructed image is selected from a group consisting of a first MIT image, a first MAT-MI image, a first ultrasound image, a first PET image, a first CT image, a first MRI image, a first microwave tomography image, a first pressure tomography image, a first optical coherence tomography image, a first doppler ultrasonography image, a first mammogram image, a first imaging PPG image, a first microwave tomography image, a first magneto-acoustic-electrical tomography image, a first thermoacoustic tomography image, a first thermoacoustic molecular tomography image, a first magnetically mediated thermoacoustic imaging image, a first microwave induced thermal acoustic tomography image, a first single-photon emission computed tomography image, a first Lorentz force reconstructed image and a first magneto-photo-acoustic imaging image; and
a post processing device coupled to the processing device and configured to receive the first reconstructed image and post-process the first reconstructed image through a neural network algorithm to generate a second reconstructed image, wherein the second reconstructed image is selected from a group consisting of a second MIT image, a second MAT-MI image, a second ultrasound image, a second PET image, a second CT image, a second MRI image, a second microwave tomography image, a second pressure tomography image, a second optical coherence tomography image, a second doppler ultrasonography image, a second mammogram image, a second imaging PPG image, a second microwave tomography image, a second magneto-acoustic-electrical tomography image, a second thermoacoustic tomography image, a second thermoacoustic molecular tomography image, a second magnetically mediated thermoacoustic imaging image, a second microwave induced thermal acoustic tomography image, a second single-photon emission computed tomography image, a second Lorentz force reconstructed image and a second magneto-photo-acoustic imaging image.

2. The post processing system of claim 1, wherein the post processing device is further configured to post-process the first reconstructed image through the neural network algorithm based on the measuring data to generate a third reconstructed image, wherein the third reconstructed image is selected from a group consisting of a third MIT image, a third MAT-MI image, a third ultrasound image, a third PET image, a third CT image, a third MRI image, a third microwave tomography image, a third pressure tomography image, a third optical coherence tomography image, a third doppler ultrasonography image, a third mammogram image, a third imaging PPG image, a third microwave tomography image, a third magneto-acoustic-electrical tomography image, a third thermoacoustic tomography image, a third thermoacoustic molecular tomography image, a third magnetically mediated thermoacoustic imaging image, a third microwave induced thermal acoustic tomography image, a third single-photon emission computed tomography image, a third Lorentz force reconstructed image and a third magneto-photo-acoustic imaging image.

3. The post processing system of claim 1, wherein the neural network algorithm comprises at least one input layer, at least one output layer and at least one hidden layer, and the post processing device is further configured to input at least one training image to the at least one input layer and input at least one actual image corresponding to the at least one training image to the at least one output layer to determine a plurality of weighting parameters between the at least one hidden layer and the at least one input layer, and between the at least one hidden layer and the at least one output layer.

4. The post processing system of claim 3, wherein the processing device is further configured to generate the at least one training image through the first solving method based on at least one training data and send the at least one training image to the post processing device, wherein the at least one training data is measured by the image capturing device.

5. The post processing system of claim 3, wherein the post processing device is further configured to determine the weighting parameters based on noise data.

6. The post processing system of claim 1, wherein the solving method is a linear algorithm.

7. The post processing system of claim 1, wherein the solving method is a nonlinear iteration method.

8. A post processing method for images, comprising:
by a processing device, generating a first reconstructed image through a solving method based on measuring data, wherein the measuring data is measured by an image capturing device, wherein the measuring data is measured by an image capturing device, and the image capturing device is selected from a group consisting of a magnetic induction tomography (MIT) device, a magnetoacoustic tomography with magnetic induction (MAT-MI) device, an ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device, an imaging photoplethysmogram (PPG) device, a microwave tomography device, a magneto-acoustic-electrical tomography device, a thermoacoustic tomography device, a thermoacoustic molecular tomography device, a magnetically mediated thermoacoustic imaging device, a microwave induced thermal acoustic tomography device, a single-photon emission computed tomography device, a Lorentz force electrical impedance tomography device and a magneto-photo-acoustic imaging device, and the first reconstructed image is selected from a group consisting of a first MIT image, a first MAT-MI image, a first ultrasound image, a first PET image, a first CT image, a first MRI image, a first microwave tomography image, a first pressure tomography image, a first optical coherence tomography image, a first doppler ultrasonography image, a first mammogram image, a first imaging PPG image, a first microwave tomography image, a first magneto-acoustic-electrical tomography image, a first thermoacoustic tomography image, a first thermoacoustic molecular tomography image, a first magnetically mediated thermoacoustic imaging image, a first microwave induced thermal acoustic tomography image, a first single-photon emission computed tomography image, a first Lorentz force reconstructed image and a first magneto-photo-acoustic imaging image; and
by a post processing device, post-processing the first reconstructed image through a neural network algorithm to generate a second reconstructed image, wherein the second reconstructed image is selected from a group consisting of a second MIT image, a second MAT-MI image, a second ultrasound image, a second PET image, a second CT image, a second MRI image, a second microwave tomography image, a second pressure tomography image, a second optical coherence tomography image, a second doppler ultrasonography image, a second mammogram image, a second imaging PPG image, a second microwave tomography image, a second magneto-acoustic-electrical tomography image, a second thermoacoustic tomography image, a second thermoacoustic molecular tomography image, a second magnetically mediated thermoacoustic imaging image, a second microwave induced thermal acoustic tomography image, a second single-photon emission computed tomography image, a second Lorentz force reconstructed image and a second magneto-photo-acoustic imaging image.

9. The post processing method of claim 8, further comprising:
by the post processing device, post-processing the first reconstructed image through the neural network algorithm based on the measuring data to generate a third reconstructed image, wherein the third reconstructed image is selected from a group consisting of a third MIT image, a third MAT-MI image, a third ultrasound image, a third PET image, a third CT image, a third MRI image, a third microwave tomography image, a third pressure tomography image, a third optical coherence tomography image, a third doppler ultrasonography image, a third mammogram image, a third imaging PPG image, a third microwave tomography image, a third magneto-acoustic-electrical tomography image, a third thermoacoustic tomography image, a third thermoacoustic molecular tomography image, a third magnetically mediated thermoacoustic imaging image, a third microwave induced thermal acoustic tomography image, a third single-photon emission computed tomography image, a third Lorentz force reconstructed image and a third magneto-photo-acoustic imaging image.

10. The post processing method of claim 8, wherein the neural network algorithm comprises at least one input layer, at least one output layer and at least one hidden layer, and the post processing method further comprises:
by the post processing device, inputting at least one training image to the at least one input layer, and inputting at least one actual image corresponding to the at least one training image to the at least one output layer to determine a plurality of weighting parameters between the at least one hidden layer and the at least one input layer, and between the at least one hidden layer and the at least one output layer.

11. The post processing method of claim 10, further comprising:
by the processing device, generating the at least one training image through the solving method based on at least one training data, wherein the at least one training data is measured by the image capturing device.

12. The post processing method of claim 10, further comprising:
by the post processing device, determining the weighting parameters based on noise data.

13. The post processing method of claim 8, wherein the solving method is a linear algorithm.

14. The post processing method of claim 8, wherein the solving method is a nonlinear iteration method.

15. A non-transitory computer readable medium to store a plurality of instructions for commanding a computer to execute a post processing method for images, and the post processing method comprising steps of:
by a processing device, generating a first reconstructed image through a solving method based on measuring data, wherein the measuring data is measured by an image capturing device, wherein the measuring data is measured by an image capturing device, and the image capturing device is selected from a group consisting of a magnetic induction tomography (MIT) device, a magnetoacoustic tomography with magnetic induction (MAT-MI) device, an ultrasound device, a positron emission tomography (PET) device, a computed tomography (CT) device, a magnetic resonance imaging (MRI) device, a microwave tomography device, a pressure tomography device, an optical coherence tomography device, a doppler ultrasonography device, a mammogram device, an imaging photoplethysmogram (PPG) device, a microwave tomography device, a magneto-acoustic-electrical tomography device, a thermoacoustic tomography device, a thermoacoustic molecular tomography device, a magnetically mediated thermoacoustic imaging device, a microwave induced thermal acoustic tomography device, a single-photon emission computed tomography device, a Lorentz force electrical impedance tomography device and a magneto-photo-acoustic imaging device, and the first reconstructed image is selected from a group consisting of a first MIT image, a first MAT-MI image, a first ultrasound image, a first PET image, a first CT image, a first MRI image, a first microwave tomography image, a first pressure tomography image, a first optical coherence tomography image, a first doppler ultrasonography image, a first mammogram image, a first imaging PPG image, a first microwave tomography image, a first magneto-acoustic-electrical tomography image, a first thermoacoustic tomography image, a first thermoacoustic molecular tomography image, a first magnetically mediated thermoacoustic imaging image, a first microwave induced thermal acoustic tomography image, a first single-photon emission computed tomography image, a first Lorentz force reconstructed image and a first magneto-photo-acoustic imaging image; and
by a post processing device, post-processing the first reconstructed image through a neural network algorithm to generate a second reconstructed image, wherein the second reconstructed image is selected from a group consisting of a second MIT image, a second MAT-MI image, a second ultrasound image, a second PET image, a second CT image, a second MRI image, a second microwave tomography image, a second pressure tomography image, a second optical coherence tomography image, a second doppler ultrasonography image, a second mammogram image, a second imaging PPG image, a second microwave tomography image, a second magneto-acoustic-electrical tomography image, a second thermoacoustic tomography image, a second thermoacoustic molecular tomography image, a second magnetically mediated thermoacoustic imaging image, a second microwave induced thermal acoustic tomography image, a second single-photon emission computed tomography image, a second Lorentz force reconstructed image and a second magneto-photo-acoustic imaging image.

16. The non-transitory computer readable medium of claim 15, wherein the method further comprises:
by the post processing device, post-processing the first reconstructed image through the neural network algorithm based on the measuring data to generate a third reconstructed image, wherein the third reconstructed image is selected from a group consisting of a third MIT image, a third MAT-MI image, a third ultrasound image, a third PET image, a third CT image, a third MRI image, a third microwave tomography image, a third pressure tomography image, a third optical coherence tomography image, a third doppler ultrasonography image, a third mammogram image, a third imaging PPG image, a third microwave tomography image, a third magneto-acoustic-electrical tomography image, a third thermoacoustic tomography image, a third thermoacoustic molecular tomography image, a third magnetically mediated thermoacoustic imaging image, a third microwave induced thermal acoustic tomography image, a third single-photon emission computed tomography image, a third Lorentz force reconstructed image and a third magneto-photo-acoustic imaging image.

17. The non-transitory computer readable medium of claim 15, wherein the neural network algorithm comprises at least one input layer, at least one output layer and at least one hidden layer, and the post processing method further comprises:
by the post processing device, inputting at least one training image to the at least one input layer, and inputting at least one actual image corresponding to the at least one training image to the at least one output layer to determine a plurality of weighting parameters between the at least one hidden layer and the at least one input layer, and between the at least one hidden layer and the at least one output layer.

18. The non-transitory computer readable medium of claim 17, wherein the method further comprises:
by the processing device, generating the at least one training image through the solving method based on at least one training data, wherein the at least one training data is measured by the image capturing device.

19. The non-transitory computer readable medium of claim 17, wherein the method further comprises:
by the post processing device, determining the weighting parameters based on noise data.

20. The non-transitory computer readable medium of claim 15, wherein the solving method is a linear algorithm or a nonlinear iteration method.
